(19) United States
(12) Patent Application Publication
(10) Pub. No.: US 2004/0244272 A1
(43) Pub. Date: Dec. 9, 2004

(54) Case for longline storage and/or preparation

(76) Inventor: Dominique Michon, Le Croisic (FR)

Correspondence Address: YOUNG & THOMPSON, 745 SOUTH 23RD STREET, 2ND FLOOR, ARLINGTON, VA, 22202, US

(21) Appl. No.: 10/489,768

(22) PCT Filed: Sep. 17, 2002
(86) PCT No.: PCT/FR02/03174

(30) Foreign Application Priority Data
Sep. 17, 2001 (FR) 01/11986

(51) Int. Cl. A01K 97/06

(52) U.S. Cl. 43/57.1

(57) ABSTRACT

The box includes elements for storing fish hooks which consist of a rack (36) in the form of a flexible incised band wherein are pinched the bottom of the branches (4) and, of an outer rack (32) which serves as a prop for the fish hooks (3), retaining them at their hooks or the knot (41) and, of an inner rack (34) fitted with slots for housing the branches and protect them from the mother line (2) during spinning. The storage elements are in the form of rectilinear bars (10) for boxes made of a parallelepiped casing fitted with stanchions (6) at each of its angles. According to an embodiment variation, the storage elements are in the form of a crown forming the upper rim of a truncated box.

This invention concerns a box for storing and/or preparing a long fishing line (“palangre”).

A long fishing line may comprise close to one thousand fish hooks. Each fish hook is installed on a branch, which branch is attached to a mother line whereof the diameter is of the order of 3-4 times that of the branch.

The document FR-2 457 071 describes a box for long line which enables to store the mother line in a tub or casing and to install each fish hook on a pack or magazine in the form of a bar.

Such bars include a kind of comb formed of an incised flexible ribbon made of rubber. Each incision enables to house and to pinch the bottom of the branch in place, beside the fish hook. Pinching sometimes proves insufficient to maintain correctly the fish hook and its bait. The pinching load should not be too great either; if it is too great, the baits may be torn away at the start if acceleration is too sudden.

Moreover, with this material, the mother line slides directly on the rubber ribbon and consequently the latter catches each knot, hence a certain degree of disturbance when spinning.

This invention aims at improving this type of box to remedy the shortcomings aforementioned.

The improvements made also enable better separation of the fish hooks, reduce the risks of line entanglement and prevent the baits from being torn away when spinning the line.

The box according to the invention includes means for storing fish hooks and/or baits, which means comprise—on the one hand, at least one rack made of a flexible band of rubber type material, this band is incised to enable to store and to pinch the end of the branches, and,—on the other hand, moreover, behind said flexible band, on the external portion of the box, downstream, a rigid prop in the form of a rack, which enables to catch and to hang the fish hook with its possible bait, which fish hook is held by its own hook or the knot, the shank of said fish hook being arranged in a appropriate notch provided on said rack support.

According to the invention, the notch made in the rack support, has a width which is substantially greater than the diameter of the shank of the fish hook and its depth is such that it enables to maintain and to guide said shank in a vertical plane while enabling the latter to move in a pendulum fashion when attaching the baits.

According to another embodiment of the invention, the prop also serves as a launching ramp when spinning the line and its length, as well as the length of the notch are of the order of 10 to 15 mm.

According to another preferential embodiment of the invention, the storage means include moreover, ahead of the flexible band, on the inner portion of the box, a rack in the form of a comb which serves as a ramp or as a springboard for the mother line, the slots of said rack have a width which corresponds to the diameter of the branches in order to accommodate the latter therein and to protect the latter when spinning the line, which rack prevents branch from being dragged accidentally by the mother line, it confers to said branch a path which prevents any friction and any entanglement between said mother line and the rack in the form of a flexible band.

According to a first embodiment, the box is made of a parallelepiped casing and of stanchions which extend vertically at each angle of said casing, which stanchions are in the form of an angle bracket whereof each wing has a U-shaped section, and for this box, the storage means making up the fish hook magazine, are in the form of rectilinear bars, which bars are superimposed between said stanchions, open, forming between themselves windows through which runs the mother line so that spinning may be continuous without needing to disassemble the empty bars, each bar comprises at its ends, positioning and guiding means on said stanchions, which guiding means enabling to install the bar either on the plane of the walls of said casing, or in a tilted position for spinning, with a tilt of the order of 60° with respect to the vertical, which bar also includes, at its upper section, the means for storing fish hooks and baits as the case may be, which means consist of the flexible band accommodated in a groove of said bar, which flexible band is arranged between an external wall, provided in the form of a supporting rack fitted with slots for letting through each shank, and another rack fitted with slots which enable to house and to protect the branches.

According to another embodiment of the invention, the bars are made of aluminium, composed of two profiles: an upper profile which enables to store fish hooks and baits as the case may be, and a lower profile which serves as a pin, co-operating with the stanchions, which pin is provided to lock the bar in two stable positions: a stable vertical position and a stable position for spinning the line, tilted to approximately 60° with respect to the vertical position, switching from one position to the other being obtained by elastic deformation of the wings of said stanchions, caused by said pin, which pin is automatically locked in either of both its extreme positions.

Still according to the invention, the rack in the form of a flexible band, is associated with means which enable to compress or to stretch said band, to suit the requirements, to modify the pinching load at the incisions, which means consist for instance in locking said band in its housing after appropriate selection at its length.

According to a second embodiment, the box is made of a circular tub made of thermoplastic material or reinforced resin for instance, and the means for storing fish hooks are provided at the upper rim of said tub, which means comprise—an open circular groove, undercut, for accommodating the rack in the form of a flexible band, and—on the one hand, outside said band, downstream, a compact supporting rack added on directly at the rim for attaching the fish hooks, and—on the other hand, inside, upstream of said band, a rack provided on the inner rim for housing the branches, forming moreover a rounded surface to guide the mother line.

According to another embodiment of the invention, the split groove enabling to house the incised flexible band, includes an inlet in the form of a ramp which enables to slide the padding of said band, and to thread the latter in the groove on the whole circumference of the rim of the box, which band has a length selected in order optimum pinching of the branches, at the incisions. This flexible band serves as a trigger, to a certain extent; it sets and adjusts the starting conditions of the branch.

Still according to the invention, the outer wall of the edge of the box, under the rack support, is provided in the form of a very smooth and very hard wall, in order to prevent any risk of catching accidentally the tip of the fish hook, when spinning, which wall extends over a height greater than the length of the fish hooks used.

According to another possibility of the invention, the box is made of two parts: a part forming the tub properly speaking and a part corresponding to its crown, of a more technical character which includes means in the form of groove for instance to snap onto the rim of the upper tub provided to that effect, which crown may also form a kind of complementary magazine that may be juxtaposed on another crown.

According to another embodiment variation, the box is associated with a baiting plate or crown which is fitted on its periphery, with a rack acting as a prop for ballasts or floats, and/or with partitions which form housings intended for live or frozen baits.

The invention will be detailed further using the following description and the appended drawings given for exemplificative purposes, and wherein:

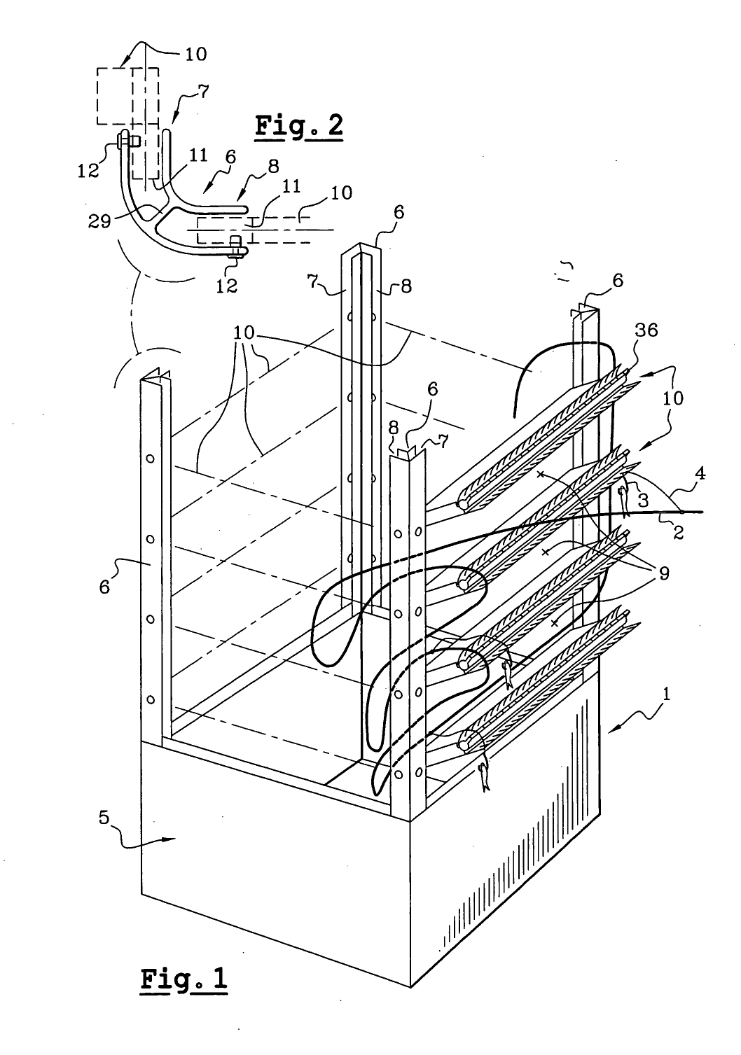

FIG. 1 represents a long line box according to a first embodiment of the invention;

FIG. 2 represents the cross section of a stanchion;

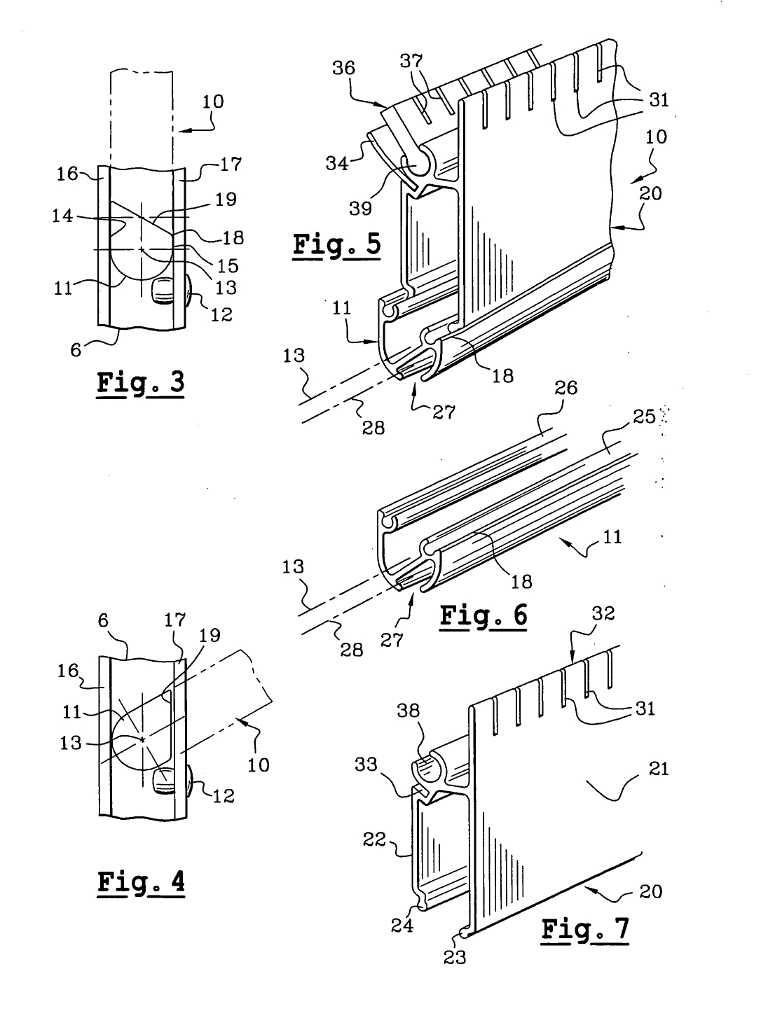

FIG. 3 represents schematically and partially, at greater scale than for FIG. 2, a portion of a bar in normal storage position, seen laterally and installed in a stanchion;

FIG. 4 represents a portion of the bar as FIG. 3, in spinning position of the line;

FIG. 5 represents a portion of a rectilinear bar, as a perspective view;

FIG. 6 represents the lower profile of a bar, acting as a pin;

FIG. 7 represents the upper profile of the bar;

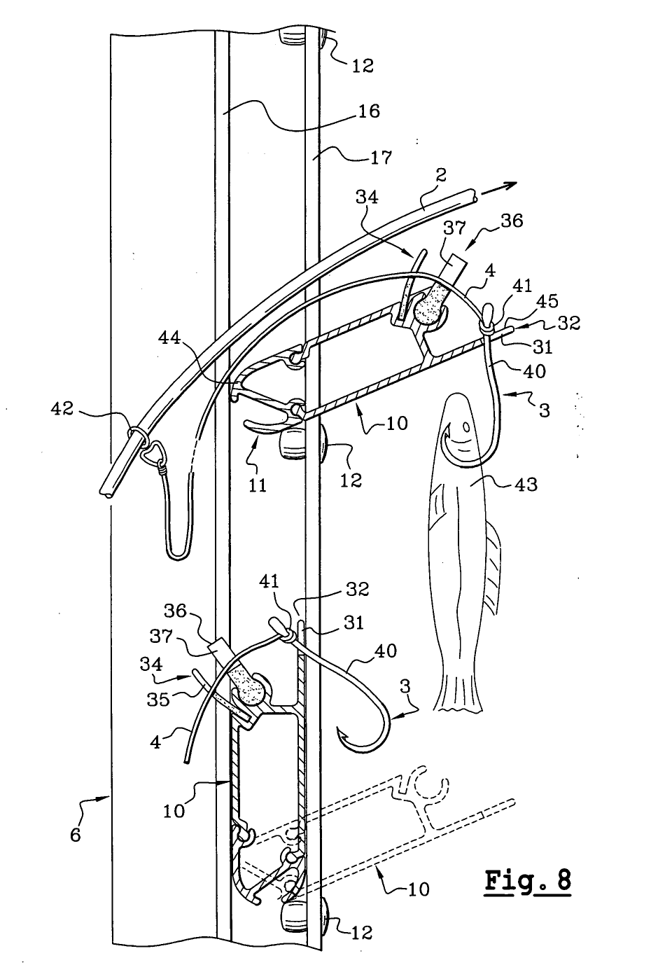

FIG. 8 represents, seen laterally and transversally, rectilinear bars installed between the stanchions;

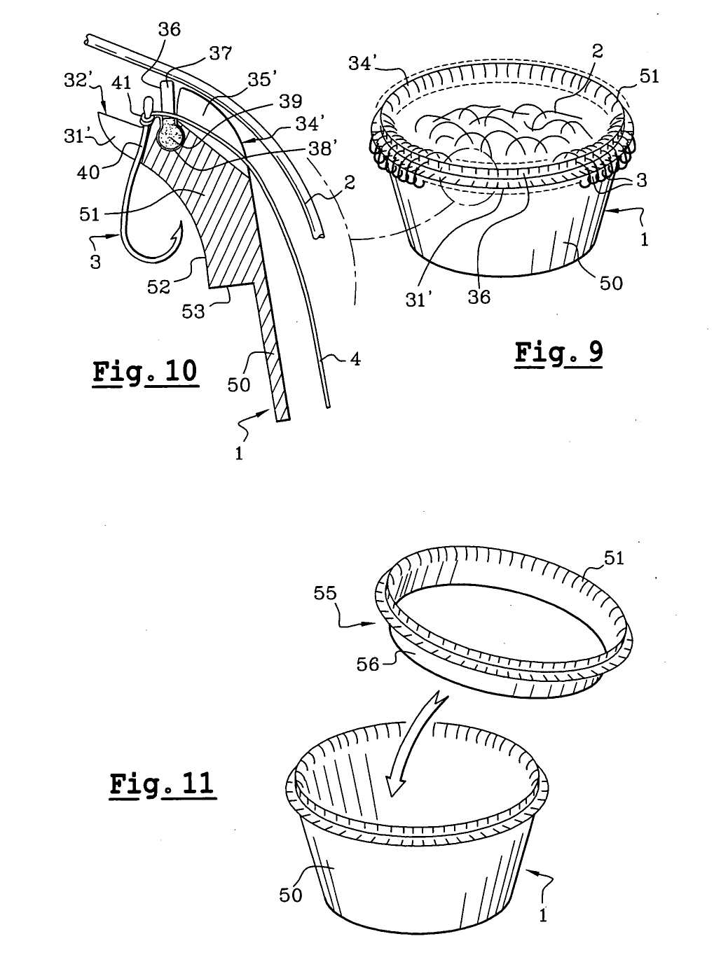

FIG. 9 represents schematically, an embodiment variation of the long fishing line box, which is in the form of a circular tub;

FIG. 10 represents as a cross section, the detail of the rim of the box in the form of a tub;

FIG. 11 represents a box whereof the storage capacities are completed by a circular magazine in the form of a crown, which is placed on the rim of said box;

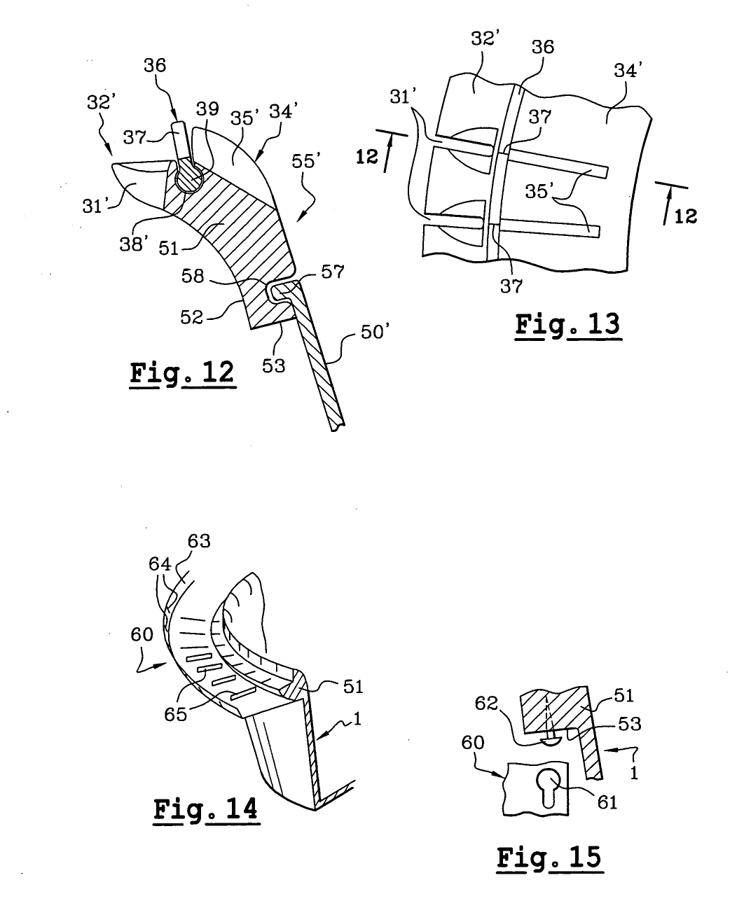

FIG. 12 represents a cross-sectional part according to 12-12 of an embodiment variation of the box which is composed of a tub and of a snap-on crown;

FIG. 13 represents a position of the crown, as a top view;

FIG. 14 represents a portion of the round box fitted with a baiting plate in the form of a crown;

FIG. 15 represents schematically the assembly means of the plate, on the rim of the box.

The box represented schematically on FIG. 1 corresponds to a first embodiment. This box 1 enables to store a pelagic long fishing line composed of a mother line 2 on which fish hooks 3 and ballasts or floats, as the case may be, are attached, not represented.

Each fish hook 3 is connected to the mother line 2 by means of a branch 4.

The box 1 is composed of a parallelepiped casing wherein is stored the mother line 2. This casing 5 is open at its upper section and includes in each of its angles, stanchions 6 which extend vertically. These stanchions 6 are provided in the form of angle brackets and each branch or wing 7 and 8 has a U-shaped section. These stanchions 6 are provided to accommodate, in the extension of the sides of the casing 5, storage means or magazines, for the fish hooks 3 with or without the baits.

The box is represented on FIG. 1 with four magazines in the form of a bar 10, superimposed. It includes, similarly, on each of the other sides, bars represented simply as mixed dotted lines. These open sides include, between the bars, a space or window 9 which enables to let through the mother line 2.

When spinning, the mother line 2 is extracted from the casing 5 as the boat progresses; it comes out of the casing 5 automatically and drags the fish hooks 3 with the branches 4, emptying each bar 10 after one another, side by side.

The presence of the windows 9 between the bars 10, enables to spin the line continuously without needing to remove the empty bars.

During haulage, an operator may store directly the mother line in the casing 5 and re-position the fish hooks 3 and the branches 4, gradually on each of the bars 10, in the reverse order of spinning, side by side.

FIG. 2 shows a cross section of the stanchions 6. These stanchions are in the form of angle brackets and each of their wings or branches 7, 8, has a U-shaped section to accommodate the bars 10 and in particular the lower part of these bars which form a kind of pin 11.

These pins 11 are positioned and locked vertically with respect to the stanchions 6, by means of stops, 12 which are for instance made of simple rivets installed in each of the wings 7, 8 of the stanchions.

To place a bar 10 between two stanchions 6, it suffices to tilt it while inserting the pin 11 on one side, then on the other side in the corresponding stanchion.

FIG. 3 shows a portion of stanchion 6 wherein is integrated a bar 10 represented schematically and partially as a mixed dotted line. The lower part of the bar forming the pin 11, includes a semi-circular lower portion and an upper portion in the form of a trapezoid. The circular portion is centred on the pin 13 which lies on the middle plane of the bar 10, and the trapezoid includes a large base 14 and a small base 15 in the extension of the faces of said bar, which is inscribed between the wings 16 and 17 of the stanchion 6.

When tipping the bar 10 around the pin 13, by an angle of the order of 60°, the ridge 18 which is situated between the small side 15 of the trapezoid and the tilted portion 19 of this very trapezoid, presses against the external wing 17 of the stanchion 6 to switch from the storage position of FIG. 3 to the spinning position, as represented on FIG. 4, in which position the surface tilted 19 of the trapezoid bears against said wing 17 of the stanchion 6.

This spinning position is also stable since the pin 11 is embedded between the wings 16 and 17 of the stanchion 6.

The pivoting movements of the bars 10 take place with elastic deformation of the wings 16 and 17 of the stanchions 6, and the bar is thus locked between said wings in the storage position and in the spinning position.

FIGS. 5 to 7 show in a more detailed way the profiles forming bars 10.

These profiles, two in number, are made of aluminium. The profile 11 which serves as a pin, forms an interchangeable wear part. The length of this profile is greater than that of the profile 20. The profile 20 serves as a magazine and its length is substantially smaller than the distance between two stanchions 6.

The profile 20 includes two walls connected together:—an outer wall 21 and—an inner wall 22. The distance between both these walls corresponds to the space between the wings 16 and 17 of the stanchions 6.

The lower end of each of the walls 21, 22 of the profile 20 is fitted with paddings which co-operate with grooves of equivalent shape provided at the profile 11 and in particular at the surface 19, i.e. the tilted surface of the trapezoid as defined previously in connection with the FIGS. 3 and 4.

The paddings 23 and 24 of the profile 20 co-operate with grooves 25 and 26 of the profile 11 respectively.

The profiles 11 and 20 which form the bars 10 are immobilised with respect to one another by a kind of pinching effect which is due to a differential gap between the paddings 23 and 24 of the upper profile 20 and the grooves 25 and 26 of the lower profile 11 acting as a pin.

The profile 11, as represented on FIGS. 5 and 6, shows the ridge 18 as detailed previously in connection with FIGS. 3 and 4; this ridge 18 enables to lock the position of the bar 10 with respect to the stanchion 6.

The profile 11 still includes, at its lower part, at the rounded portion, a hollow section 27 which enables for instance to house a kind of screw, not represented, centred on the pin 28, which screws enables to lock the bars with respect to the stanchion 6 and in particular with respect to the central partition 29 of said stanchion as represented on FIG. 2.

The profile 20 includes at its upper end, arrangements which enable to form directly or to receive the different racks.

The upper end of the outer wall 21 of the profile 20 includes notches 31 spaced regularly which form a supporting rack 32, for housing the fish hooks 3. The interval between two notches 31 is for instance of the order of 2 cm. The length of the notch 31 is of the order of 1 to 1.5 cm.

The upper section of the inner wall 22 of the profile 20, includes a first longitudinal groove 33 which enables to embed, as represented on FIG. 5, a rack 34. This rack 34 is in the form of a band of relatively rigid material, fitted with slots 35 which are situated opposite the notches 31, for housing and especially for protecting the branches 4 when spinning the line. The width of the slots 35 is slightly greater than the diameter of the branches 4.

The rack 34 is tilted to 45° on the wall 22, and forms a kind of padding and of guiding springboard for the mother line during spinning.

Between the racks 32 and 34 lies the rack 36, on FIG. 8, made of a ribbon or band of flexible material such as rubber which is fitted with incisions 37 situated in the extension of the notches 31, for housing the bottom of the branches 4 and especially holding said incisions of the band tight against one another which form each a kind of trigger. The traction on the branch 4 will open the incision 37 wherein is pinched the branch.

The pinching load of the bottom of the branch 4, at the incision 37, may be adjusted by compressing or stretching the band forming the rack 36. This band may have a length greater or smaller than that of its housing and be locked in this housing by any appropriate means in order to be stretched or compressed in said housing.

The housing is in the form of a groove 38, of open circular section, to accommodate the padding 39 situated at the lower end of the rack 36. The groove 38 is situated above the groove 33. The rack 36 is tilted towards the inside of the box, with respect to the wall 22 of the bar.

FIG. 8 shows in a more detailed way, the different bars and the assembly of the line ends, i.e. the branches 4 and the fish hooks 3 in the racks.

The lower part of FIG. 8 shows a bar 10 in normal storage position of a bottom part of a branch; this bar is accommodated in the stanchions 6 whereof one appears on said FIG. 8.

Still at the lower part of this FIG. 8, a bar 10 is represented as a mixed thin doted line in its normal spinning position, possibly its baiting position, i.e. in a position which enables an operator to take the fish hooks one by one and to install a bait thereto.

The bar 10 represented at the lower section of FIG. 8, accommodates a branch 4 which runs first of all through the rack 34 housed in the slot 35, then in the rack 36, pinched in the incision 37, and the shank 40 of the fish hook 3 is positioned in a notch 31 of the supporting rack 32, its tip protruding outside the wall 21 of the bar and of the box, whereas the blade or the hook of said fish hook, is situated between said rack 36 and said supporting rack 32, retained by the latter.

Indeed, when the bar 10 has been tipped, as represented at the top of FIG. 8, the knot 41 between the fish hook 3 and the branch 4 enables to retain said fish hook to the notch 31 of the supporting rack 32, regardless of the load attached to said fish hook, which fish hook is thus perfectly stabilised to cope with the movements of the boat.

The bar 10 situated at the upper section of FIG. 8 is in tilted position for spinning the line. The mother line 2 appears on Figure, and the branch 4 is connected to this mother line by means of a sprocket 42 for instance. A bait 43 is attached to the fish hook 3 as well as ballasts or floats at regular intervals.

When spinning the mother line 2, it should be noted that this mother line may slide on the rounded part 44 of the pin 11 and on the rack 34. Along with the spinning of the mother line 2, the branch 4 leaves the rack 34, then the rack 36 and finally the fish hook is ejected from the rack 32, while sliding on the prop 45 which serves as a launching ramp.

The notches 31 have a width which corresponds to the width of the shank 40 of the fish hook with a depth which is sufficient to maintain said fish hook in a vertical position to avoid any entanglement with the neighbouring fish hooks and baits. The length of the launching ramp of the prop 45 and of the notch 32 is of the order of 10 to 15 mm for further guiding the fish hook when spinning.

FIG. 1 shows clearly the path of the mother line 2 to switch from one bar 10 to another. The mother line 2 drags first of all the baits situated on the upper bar on one side of the box, then the baits of the bar 10 immediately below etc . . . and when a side is completed, it should be noted that the mother line 2 starts the upper bar 10 of an adjoining side, etc . . . , thereby spinning all the fish hooks which may, as specified above, be one thousand in number for instance, and this, without needing to disassemble the bars which are empty.

On the embodiment of FIG. 1, the bars 10 are rectilinear in shape. FIG. 9 shows an embodiment variation wherein the fish hooks are stored on a circular magazine. The box 1 is in fact made of a tub 50 generally truncated in shape for instance, and its upper section or rim 51 is in the form of a crown which is provided in order to form several racks as detailed above.

This box may also, as detailed below on FIG. 12, be made of two parts assembled together, of thermoplastic material or of fibre-reinforced resin.

The racks of the crown appear on FIGS. 10 and 12. The upper rim 51 of the box, as represented on FIG. 10 or FIG. 12, is relatively compact in shape; it includes a first internal rack 34′ fitted with slots 35′ which enable to house the branches 4. This rack 34′ has a rounded profile forming a kind of vault to act as a guide and as a springboard for the mother line 2.

The slots 35′ provided at the rack 34′ have a width which is of the same order as the diameter of the branch 4, vastly smaller than the diameter of the mother line.

Behind the rack 34′, going outwardly, i.e. downwards, lies the rack 36 composed of a flexible band of rubber type material. This rack 36 is identical to the rack used on the bars 10 and includes a padding 39 which is housed in a groove 38′ of complementary shape provided in the rim 51. The incisions 37 enable to maintain the bottom of the branch 4 and to stabiliser the position of the fish hook 3 on its supporting rack 32′.

The selection of the length of the band forming the rack 36, enables to compress more or less this band in the groove 38′, and to modify at will the clamping load of the branches 4 in the incisions 37.

The rack 36 is placed directly behind the rack 34′ and before the supporting rack 32′ provided at the outer periphery of the rim 51. This rack 32′ includes notches 31′ whereof the width enables to house the shank 40 of the fish hooks 3, which width corresponds substantially to the diameter of said shanks 40.

This rack 32′ and the notches 31′ have for instance a length of the order of 10 to 15 mm in order to provide there again a kind of launching ramp, while acting as a prop for the fish hooks 3 and the possible baits. Indeed, the blade or hook part of the fish hook 3, with the knot 41, enables to retain the fish hook, hung by the supporting rack 32′, also authorising a pendulum movement for the baiting operation.

It should be noted that the surface of the outer wall 52 of the rim 51 is a rounded and smooth surface. This surface is also very hard because of the nature of the material used and enables at the tip of the fish hook 3 to slide, without any risk of entanglement during spinning.

The rim 51 has a thickness greater than the wall of the tub 50 in order to former a shoulder 53 which enables notably to pile up the boxes on top of one another. This rim also enables to attach a baiting plate as detailed below in connection with FIGS. 14 and 15.

The magazine and its racks may be provided directly at the upper section of a tub 50. It should be noted, on FIG. 11, that the magazine may also be in the form of a simple crown 55 composed—of the rim 51 and—of a belt 56 corresponding to the upper section of the tub 50.

This crown magazine 55 may advantageously be embedded on the upper section of a box also fitted with a circular magazine at its upper edge as well as several magazines 55 in the form of a crown may superimposed on the same box to increase the storage capacities of fish hooks. The spinning of the line is carried first of all the upper magazines, which are withdrawn as they become empty.

When hauling the line, the line is stored by installing first of all the fish hooks and branches on the rim of the box then, on a first magazine in the form of a crown 55, etc . . . to suit the requirements.

FIG. 12 represents an embodiment variation of the box which comprises a tub 50′ and a crown 55′ interconnected together by means of a kind of snap-on system. The upper rim of the tub 50′ includes a kind of peripheral padding 57, which is housed in a circular groove 58 provided on the lower internal part of the crown 55′.

This box composed of two parts, enables to use different materials for the tub and for the crown. The tub may be made of thermoplastic material, moulded or thermoformed, and the crown of more rigid material, such as fibre-reinforced resin or other.

FIG. 13 shows a portion of the crown 55′ represented on FIG. 12. The rack 34′ fitted with slots 35′ can be seen once again. This rack 34′ is followed by the rack 36 composed of the rubber flexible band, which band is fitted with incisions 37 which enable to maintain the bottom of the branches.

Finally, the supporting rack 32′ fitted with the notches 31′ can be seen.

For improved rigidity of the rack 32′ which is in the form of teeth, the thickness of material in the centre may be, as represented on FIGS. 12 and 13, greater than at the notches 31′.

FIG. 14 represents a portion of the circular box 1 fitted with a baiting plate. This plate 60 is in the form of a crown which is placed and stapled under the rim 51, on the shoulder 53. This plate 60 comprises, as represented on FIG. 15, eyehole-type orifices 61, which enable to engage the former on screws 62 spaced regularly under the shoulder 53.

Thus, this plate 60 acts as an accessory, it is removable and may be positioned to suit the requirements.

This plate includes an outer belt 63 in the form of a rack, fitted with notches 64 which enable for instance to position ballasts or floats, suspended from the fish hooks 3 instead of the baits.

Similarly, the upper surface of this plate 60 may comprise partitioning walls 65 arranged radially, to separate and maintain the baits, regardless whether these are live or frozen baits.

1. A box for storing and/or preparing long line, characterised in that it includes means for storing fish hooks (3), which consist:—of a rigid supporting rack (32, 32′) fitted with notches (31, 31′) or slots which enable to house the shank (40) of each fish hook (3) in order to hang it by its hook or by the knot, and—of a rack (36) which comprises a flexible band of rubber type material, fitted with incisions (37), in order to pinch the end of the branches (4) of said line in place, close to said fish hooks.

2. A box according to claim 1, characterised in that the notch (31, 31′) made in the supporting rack (32, 32′), has a width which corresponds substantially to the diameter of the shank (40) of the fish hook (3), its height is such that it enables to maintain and guide said shank in a vertical plane, and its length is for instance of the order of 10 to 15 mm.

3. A box according to claim 1, characterised in that the storage means include moreover, ahead of the rack (36) and arranged on the inner portion of the box, a rack (34, 34′) in the form of a comb, whereof the slots correspond to the diameter of the branches (4) for housing therein and protecting the latter when spinning the line (2), which rack (34, 34′) also serves as a guiding surface and as a springboard for the mother line (2).

4. A box according to claim 1, characterised in that on the one hand, it is made of a parallelepiped casing (5) and of stanchions (6) which extend vertically at each angle of said casing, which stanchions are in the form of angle brackets whereof each wing has a U-shaped section and in that, on the other hand, the storage means are in the form of rectilinear bars (10), each bar (10) is fitted at its ends with positioning and guiding means on said stanchions (6), which guiding means consist of a pin (11) enabling to mount said bar either in the plane of the corresponding wall of said casing, or in a tilted position for spinning, with a tilt of the order of 60° with respect to the vertical, thereby clearing a aperture or window (9) which enables to let through the mother line (2) without needing to withdraw said bars when they are empty, each bar (10) also includes, at its upper section, the means for storing and keeping fish hooks (3) and branches (4), which means consist—of the rack (36) in the form of flexible band, which flexible band is arranged between the supporting rack (32) provided on the outer wall (21) of said bar, and—another rack (34) arranged on the inner wall (22) of said bar.

5. A box according to claim 4, characterised in that the bars (10) consist of aluminium and are made of two profiles: an upper profile (20) which enables to store and to keep fish hooks (3) with the branches (4), and a lower profile (11) which serves as a pin, co-operating with the stanchions (6), which profile (11) is provided to place said bars into two stable and locked positions: a stable vertical position, in the plane of the walls of the box and a position stable for spinning the line, tilted to approx. 60° with respect to the vertical position, switching from one position to the other being obtained by elastic deformation of the wings of said stanchions, caused by said profile (11).

6. A box for storing and/or preparing a long line according to claim 4, characterised in that the rack (36), which pinches the end of the branches (4) in place, is associated with means for adjusting the pinching load, which means act on the flexible band to compress the latter or to stretch the latter to suit the requirements, in order to modify the pinching load of the incisions (37), which means consist for instance in locking said band in its housing after appropriate selection of its length.

7. A box according to claim 1, characterised in that it is made of a circular tub (50) fitted with means for storing fish hooks (3) which are provided at the upper rim (51) of said tub, which storage means comprise:—a rack (36) in the form of a flexible band of rubber type material, accommodated in an open circular groove on the top, which band is fitted with incisions (37) to house the bottom of the branch (4) and,—on the one hand, outside said rack (36), a compact supporting rack (32′), added on directly to said rim (51) for hanging said fish hooks and,—on the other hand, inside the box with respect to said rack (36), another rack (34′) provided on the inner rim and fitted with slots (35′), for housing the branches (4), forming moreover a guiding surface and a springboard for the mother line (2).

8. A box according to claim 7, characterised in that the split groove (38′) enabling to house the rack (36) in the form of a flexible band, includes an inlet in the form of a ramp which enables to slide the padding (39) of said band and to thread the latter into said groove on the whole circumference of the rim of the box, which band has a length which may be selected in order to adjust the clamping load of the bottom of the branches, at the incisions (37), which clamping load is more or less important according to the compression of said band in said groove (38′).

9. A box according to claim 7, characterised in that the outer wall of the edge of the box, under the supporting rack (32), is provided in the form of a very smooth and very hard wall in order to prevent any risk of catching accidentally the tip of the fish hook (3), which wall extends over a height greater than the length of the fish hooks used.

10. A box according to claim 7, characterised in that it is made of two parts: a part 50′ forming the tub properly speaking and a part in the form of a crown 55′ which includes means in the form of a groove 58 co-operating with a peripheral rim 57 provided at the upper section of the tub, which rim is accommodated in said groove.

11. A box according to claim 1, characterised in that it includes a baiting plate or crown (60), fitted on its periphery, of a rack (63) acting as a prop for ballasts or for floats, and/or as partitions (65) which form housings intended for live or frozen baits.

12. A box according to the claim 2, characterised in that the storage means include moreover, ahead of the rack (36) and arranged on the inner portion of the box, a rack (34, 34′) in the form of a comb, whereof the slots correspond to the diameter of the branches (4) for housing therein and protecting the latter when spinning the line (2), which rack (34, 34′) also serves as a guiding surface and as a springboard for the mother line (2).

13. A box according to claim 2, characterised in that on the one hand, it is made of a parallelepiped casing (5) and of stanchions (6) which extend vertically at each angle of said casing, which stanchions are in the form of angle brackets whereof each wing has a U-shaped section and in that, on the other hand, the storage means are in the form of rectilinear bars (10), each bar (10) is fitted at its ends with positioning and guiding means on said stanchions (6), which guiding means consist of a pin (11) enabling to mount said bar either in the plane of the corresponding wall of said casing, or in a tilted position for spinning, with a tilt of the order of 60° with respect to the vertical, thereby clearing a aperture or window (9) which enables to let through the mother line (2) without needing to withdraw said bars when they are empty, each bar (10) also includes, at its upper section, the means for storing and keeping fish hooks (3) and branches (4), which means consist—of the rack (36) in the form of flexible band, which flexible band is arranged between the supporting rack (32) provided on the outer wall (21) of said bar, and—another rack (34) arranged on the inner wall (22) of said bar.

14. A box according to claim 3, characterised in that on the one hand, it is made of a parallelepiped casing (5) and of stanchions (6) which extend vertically at each angle of said casing, which stanchions are in the form of angle brackets whereof each wing has a U-shaped section and in that, on the other hand, the storage means are in the form of rectilinear bars (10), each bar (10) is fitted at its ends with positioning and guiding means on said stanchions (6), which guiding means consist of a pin (11) enabling to mount said bar either in the plane of the corresponding wall of said casing, or in a tilted position for spinning, with a tilt of the order of 60° with respect to the vertical, thereby clearing a aperture or window (9) which enables to let through the mother line (2) without needing to withdraw said bars when they are empty, each bar (10) also includes, at its upper section, the means for storing and keeping fish hooks (3) and branches (4), which means consist—of the rack (36) in the form of flexible band, which flexible band is arranged between the supporting rack (32) provided on the outer wall (21) of said bar, and—another rack (34) arranged on the inner wall (22) of said bar.

15. A box according to claim 2, characterised in that it is made of a circular tub (50) fitted with means for storing fish hooks (3) which are provided at the upper rim (51) of said tub, which storage means comprise:—a rack (36) in the form of a flexible band of rubber type material, accommodated in an open circular groove on the top, which band is fitted with incisions (37) to house the bottom of the branch (4) and,—on the one hand, outside said rack (36), a compact supporting rack (32′), added on directly to said rim (51) for hanging said fish hooks and,—on the other hand, inside the box with respect to said rack (36), another rack (34′) provided on the inner rim and fitted with slots (35′), for housing the branches (4), forming moreover a guiding surface and a springboard for the mother line (2).

16. A box according to claim 3, characterised in that it is made of a circular tub (50) fitted with means for storing fish hooks (3) which are provided at the upper rim (51) of said tub, which storage means comprise:—a rack (36) in the form of a flexible band of rubber type material, accommodated in an open circular groove on the top, which band is fitted with incisions (37) to house the bottom of the branch (4) and,—on the one hand, outside said rack (36), a compact supporting rack (32′), added on directly to said rim (51) for hanging said fish hooks and,—on the other hand, inside the box with respect to said rack (36), another rack (34′) provided on the inner rim and fitted with slots (35′), for housing the branches (4), forming moreover a guiding surface and a springboard for the mother line (2).

17. A box according to claim 4, characterised in that it is made of a circular tub (50) fitted with means for storing fish hooks (3) which are provided at the upper rim (51) of said tub, which storage means comprise:—a rack (36) in the form of a flexible band of rubber type material, accommodated in an open circular groove on the top, which band is fitted with incisions (37) to house the bottom of the branch (4) and,—on the one hand, outside said rack (36), a compact supporting rack (32′), added on directly to said rim (51) for hanging said fish hooks and,—on the other hand, inside the box with respect to said rack (36), another rack (3′) provided on the inner rim and fitted with slots (35), for housing the branches (4), forming moreover a guiding surface and a springboard for the mother line (2).

18. A box according to claim 8, characterised in that it is made of two parts: a part 50′forming the tub properly speaking and a part in the form of a crown 55′, which includes means in the form of a groove 58 co-operating with a peripheral rim 57 provided at the upper section of the tub, which rim is accommodated in said groove.

19. A box according to claim 9, characterised in that it is made of two parts: a part 50′forming the tub properly speaking and a part in the form of a crown 55′, which includes means in the form of a groove 58 co-operating with a peripheral rim 57 provided at the upper section of the tub, which rim is accommodated in said groove.
